(19) United States
(12) Patent Application Publication
(10) Pub. No.: US 2007/0234606 A1
(43) Pub. Date: Oct. 11, 2007

(54) Panel provided with at least one wall, and method for providing a three-dimensional effect in a panel

(75) Inventor: Henricus Cornelus Antonius Wensveen, Maastricht (NL)

Correspondence Address: URSULA B. DAY, ESQ., 350 FIFTH AVE., SUITE 3220, NEW YORK, NY, 10118, US

(73) Assignee: H.C.A. Wensveen, Maastricht (NL)

(21) Appl. No.: 11/611,656

(22) Filed: Dec. 15, 2006

(30) Foreign Application Priority Data
Dec. 30, 2005 (NL) 1030818

(51) Int. Cl. G09F 19/00

(52) U.S. Cl. 40/439; 345/68

(57) ABSTRACT

A panel is provided with at least one wall made of flexible material, the wall being deformable from at least one first state, wherein the wall comprises a first configuration, to at least one second state, wherein the wall comprises a second configuration, and vice versa.

The invention relates to a panel provided with at least one wall.

The invention further relates to a method for providing a three-dimensional effect in a panel comprising at least one wall.

U.S. Pat. No. 5,921,012 describes a panel provided with at least one wall. The wall comprises a three-dimensional configuration, for example a figure, a symbol or a letter. Provided in the panel is lighting allowing the three-dimensional configuration to be illuminated. Such a striking configuration of the wall of the panel can be used for advertising boards, road and warning signs.

A drawback of the known panel is that a new wall has to be produced for a new configuration in the wall of the panel.

The aim of the present invention is to provide a panel having a variable appearance.

In the case of the panel according to the invention, this aim is achieved in that the wall is made of flexible material, the wall being deformable from at least one first state, wherein the wall comprises a first configuration, to at least one second state, wherein the wall comprises a second configuration, and vice versa.

Varying the configuration of the flexible wall of the panel allows people's attention to be easily drawn. The drawing of attention can, for example, be necessary for a road sign to warn against a dangerous traffic situation. After the deforming of the wall from a first state, wherein the wall preferably comprises a substantially smooth or flat surface, to a second state, wherein the wall is for example hollow, the wall returns, preferably after a period of time to be determined in advance has elapsed, to the first state, the wall being able to assume an arbitrary number of intermediate positions between a first state and a final second state.

An embodiment of the panel according to the present invention is characterized in that at least one three-dimensional object is positioned in the panel for deforming the wall.

A three-dimensional object of this type comprises a configuration illustrating a message to be conveyed with the aid of the panel. The object allows the wall to be deformed, thus providing a three-dimensional effect in the wall. If the wall is transparent, the object, and therefore the message, is visible at all times even if the object is not in contact with the wall.

Another embodiment of the panel according to the present invention is characterized in that the wall is displaceable relative to the object, the wall being deformable from the first state, wherein the wall is preferably separated from the object, to the second state, wherein the wall is positioned at least partially against the object, and vice versa.

By displacing the object and the wall relative to each other, a configuration is provided in the wall if the object enters into contact with the flexible wall. As a result of displacing the object and the wall away from each other, the configuration, obtained with the aid of the object, disappears from the wall. Preferably, in a first state, the wall is stretched smooth and, in the second state, the wall comprises a configuration determined by the object, or vice versa. Furthermore, the flexible wall positioned against the object preferably obtains substantially the contour form of the object.

A further embodiment of the panel according to the present invention is characterized in that the panel is provided with at least one means for varying the pressure in the panel for deforming the wall from the first state to the second state, and vice versa.

Pressure allows the wall to be deformed in a simple manner. Creating a vacuum, using a vacuum pump, in the interior space of the panel causes the wall to be deformed toward the interior space of the panel. In the first state, the wall is stretched relatively flat whereas, for example, after the varying of the pressure, the wall in the second state is hollow. A shutter, allowing the interior space of the panel to enter into contact with the atmosphere, or a pump, which actively blows air into the interior space of the panel, causes the wall to be deformed from the second state back to the first state. It is also possible, once the vacuum pump has been switched off, for the flexible wall to return of its own accord, owing to the resilient properties thereof, to the first, original state without an opening actively having to be formed for this purpose in the panel. If an object is present in the interior space of the panel, the wall, in the second state, is preferably positioned at least partially against the object, assuming in this case at least partially the configuration of the object.

A further embodiment of the panel according to the invention is characterized in that the means for varying the pressure in the panel is adjustable with the aid of at least one switch, for example an interval switch.

With the aid of at least one switch, for example an interval switch, the means for varying the pressure, such as a vacuum pump, a pump for increasing the pressure in the panel and a shutter cooperating with one of the pumps, is simple to operate.

A further embodiment of the panel according to the present invention is characterized in that the switch is connected to at least one motion sensor.

With the aid of a motion sensor, people in proximity to the panel are registered, and this can give rise to the operating of the switch to deform the wall from a first state to a second state, and vice versa, so people's attention is drawn relatively quickly and a message can be conveyed with the aid of the panel.

A further embodiment of the panel according to the present invention is characterized in that the panel is provided with lighting which can be activated in an adjustable manner.

Lighting allows the states of the wall to be emphasized more easily. Moreover, lighting generally improves the appearance of the panel.

A further embodiment of the panel according to the present invention is characterized in that the flexible wall is made of rubber or latex.

Walls of this type have outstanding resilient/flexible properties allowing the various states easily to be formed in the wall. In addition, latex and/or rubber provide the panel with a special appearance. In general, the wail can be made of any material that is resilient and that is air-tight or can be made resiliently air-tight. Suitable materials include synthetic rubbers such as polyurethane elastomers (for example, Lycra/Spandex, Elastan or Dorlastan).

The aim of the method according to the present invention is to provide a method for varying the appearance of a panel.

In the case of the method according to the invention, this aim is achieved in that the wall is made of flexible material, the wall being deformed from at least one first state, wherein the wall comprises a first configuration, to at least one second state, wherein the wall comprises a second configuration, and vice versa.

A method of this type allows the configuration of the wall of a panel to be adapted in a simple manner. By varying the configuration of the wall of the panel, a method of this type allows people's attention to be drawn in a relatively simple manner for the conveying of a message with the aid of the panel.

Another embodiment of the method according to the present invention is characterized in that the wall is displaced, relative to an object positioned in the panel, from the first state, wherein the wall is preferably separated from the object, to the second state, wherein the wall is positioned at least partially against the object, and vice versa.

An object allows particularly attractive configurations temporarily to be provided in the wall in a simple manner, because the flexible wall is able to assume the contour form of the object.

A further embodiment of the method according to the present invention is characterized in that the panel comprises at least one means for varying the pressure, the varying of the pressure in the panel causing the wall to be deformed from a first state to a second state, and vice versa.

A means for varying the pressure allows a desired configuration to be obtained in a simple manner in the wall of the panel for a specific period of time. The means for varying the pressure can comprise a vacuum pump and/or a pump for increasing the pressure in the panel and can additionally comprise a shutter which can connect the interior space of the panel to the atmosphere.

The terms “flexible” and “resilient” are used in combination in the present text to describe a wall which, in the second, deformed state, has a natural proclivity to return to the original, first state.

The invention will now be described with reference to the appended figures, in which:

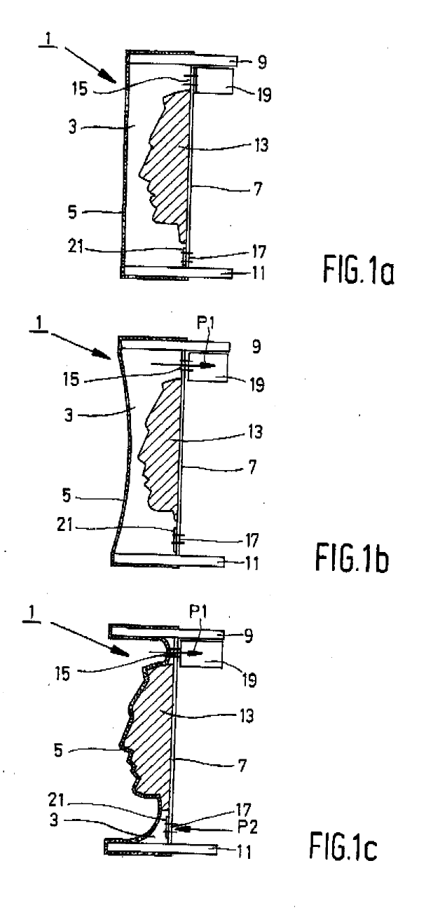

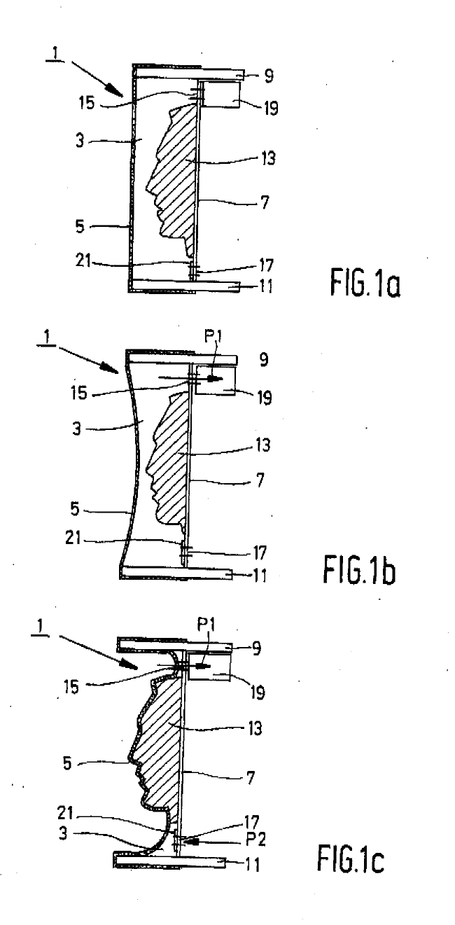

FIGS. 1a-c are schematic cross sections of the panel according to present invention.

In the various figures, identical components are provided with the same reference numerals.

FIG. 1a is a lateral cross section of a panel 1 according to the present invention. The panel 1 comprises an interior space 3, which interior space is delimited by six walls 5, 7, 9, 11, only four of which are shown.

One wall 5 is made of a flexible and/or resilient material, preferably latex or rubber. The remaining walls 7, 9, 11 are made of a relatively rigid material such as, for example, wood or a hard plastics material. The wall 5 is fastened, for example using adhesive, to the walls 9, 11 adjacent thereto (the remaining two walls are not shown).

In the interior space 3, a three-dimensional object 13 in the form of a face is fastened to the wall 7 erected opposing the flexible wall 5. Preferably, the object is positioned at a distance of, for example, 1 mm relative to the wall 7.

The wall 7 is also provided with two openings 15, 17. On the side of the wall 7 that is remote from the interior space 3 of the panel 1, a vacuum pump 19 is connected to a first opening 15. A second opening 17 is closed with the aid of a shutter or a valve 21.

The functioning of the panel 1 according to the present invention will now be explained with the aid of FIGS. 1a-1c.

FIG. 1a shows the panel 1 in the first state. In the first state, the resilient wall 5 is stretched substantially tight. Extracting air, using the vacuum pump 19, from the interior space 3 of the panel, as indicated in FIG. 1b by arrow P1, causes the flexible wall 5 to be deformed toward the interior space 3.

FIG. 1b shows the panel 1 in an intermediate state, wherein the wall 5 comprises a hollow configuration.

Extracting more air, using the vacuum pump 19, from the interior space 3 of the panel 1 will cause the wall 5 to undergo further deformation, as a result of which the wall 5 is positioned, from a specific point, against the object 13 and gradually assumes the contours of the object 13.

FIG. 1c shows the panel in the second state, wherein the wall 5 is positioned substantially completely against the object 13.

Once a predetermined period of time has elapsed, the shutter 21 can be opened. Opening the shutter 21 allows air to stream, in the direction indicated by arrow P2, into the interior space 3 of the panel 1, causing the wall 5 gradually to return from the second state to its original, first state, as illustrated in FIG. 1a. The resilient wall 5 will tend naturally to return to the first, original state.

Seen from a front view, the configuration of the panel 1 is changed over time, producing for the viewer of the panel 1 an unexpected three-dimensional effect allowing, for example, an advertising message to be conveyed.

The object 13 can comprise any desired configuration.

It is also possible for the object 13 to be omitted, the second state of the wall 5 of the panel being defined by the hollow flexible wall 5, as shown in FIG. 1b.

The speed of the deforming of the flexible wall 5 can be set as a function of the capacity of the vacuum pump 19.

Instead of a shutter or valve 21, the second opening 17 can also be provided with a pump (not shown) allowing air to be blown into the interior space 3. A pump of this type allows the flexible wall 5 to return relatively rapidly from a second state to a first state. A pump also allows a round wall 5 (not shown) to be provided.

Furthermore, it is possible for the second opening 17 to be omitted. It is also possible, once the vacuum pump 19 has been switched off, for the flexible wall 5 to return of its own accord, owing to the resilient properties thereof, to the first, original state without an opening actively having to be formed for this purpose in the panel 1. It is also possible, for returning from the second configuration to the first configuration of the wall 5, for the first opening 15, which is connected to the vacuum pump 19, to be connected to the atmosphere. It is also possible to replace the vacuum pump 19 with a pump which is able both to extract air from the interior space 3 and to blow air into the interior space 3.

The openings 15, 17 can be positioned substantially throughout the wall 7. It is also possible to form the openings 15, 17 in the object 13. At least one opening, which is connected to the vacuum pump 19, is preferably positioned after the object 13, so air is drawn out centrally from the interior 3 and the wall 5 becomes positioned against the object 13 relatively quickly. In a specific embodiment (not shown), various openings are connected to the vacuum pump 19.

The foregoing pumps and shutters or valves can be activated using an interval switch.

In another embodiment of the panel 1 according to the present invention, it is also possible to displace the object 13 relative to the wall 5 using a means suitable for this purpose such as, for example, an electric motor or with the aid of rails, via which the object 13 or the wall 5 can be displaced manually toward and away from each other. It is, in this case, possible both to displace the wall 5 toward the object 13 and to displace the object 13, optionally with the wall 7, toward the wall 5. In this embodiment, it is not necessary to provide the panel 1 with openings 15, 17. Obviously, it is possible to combine this embodiment with the means for varying the pressure for the displacing of the wall 5.

Furthermore, lighting (not shown) and at least one sound means (not shown) can be provided in the panel 1, allowing light and sound effects, supplementing the configuration in the panel 1, to be provided between the states of the wall 5. Supplementary effects of this type can be activated, together with the deforming of the flexible wall 5, by an adjustment means (not shown).

It is also possible to attach to the flexible wall 5 a print which is legible in both the first and the second state.

As a result of the variable three-dimensional configuration which can be attached in the wall 5 of the panel 1, this panel 1 can be read at all times and under all weather conditions, even in the event of snow, as a result of which the panel 1 is suitable for use as a traffic sign.

Furthermore, the object 13 is detachably fastened in the panel 1, allowing the object 13 to be exchanged, as a result of which the panel 1 can be reused.

Various parts (not shown) of the panel 1 can also be displaceable using the air extracted from the interior 3 or with the aid of other air pumps or displacement means. The panel 1 as a whole can also be displaceable.

The panel 1 according to the present invention can be used as art, in a shop window, in interior and exterior design, in stand design, in set design, in outdoor advertising and in a warning sign, etc.

1. A panel provided with at least one wall, wherein the wall is made of flexible material, the wall being deformable from at least one first state, wherein the wall comprises a first configuration, to at least one second state, wherein the wall comprises a second configuration, and vice versa.

2. The panel as claimed in claim 1, wherein at least one three-dimensional object is positioned in the panel for deforming the wall.

3. The panel as claimed in claim 2, wherein the wall is displaceable relative to the object, the wall being deformable from the first state, wherein the wall is preferably separated from the object, to the second state, wherein the wall is positioned at least partially against the object, and vice versa.

4. The panel as claimed in claim 1, wherein the panel is provided with at least one means for varying the pressure in the panel for deforming the wall from the first state to the second state, and vice versa.

5. The panel as claimed in claim 4, wherein the means for varying the pressure in the panel is adjustable with the aid of at least one switch, for example an interval switch.

6. The panel as claimed in claim 5, wherein the switch is connected to at least one motion sensor.

7. The panel as claimed in claim 1, wherein the panel is provided with lighting which can be activated in an adjustable manner.

8. The panel as claimed in claim 1, wherein the flexible wall is made of rubber or latex.

9. A method for providing a three-dimensional effect in a panel comprising at least one wall, wherein the wall is made of flexible material, the wall being deformed from at least one first state, wherein the wall comprises a first configuration, to at least one second state, wherein the wall comprises a second configuration, and vice versa.

10. The method as claimed in claim 9, wherein the wall is displaced, relative to an object positioned in the panel, from the first state, wherein the wall is preferably separated from the object, to the second state, wherein the wall is positioned at least partially against the object, and vice versa.

11. The method as claimed in claim 9, wherein the panel comprises at least one means for varying the pressure, the varying of the pressure in the panel causing the wall to be deformed from a first state to a second state, and vice versa.
